(19) United States
(12) Patent Application Publication
(10) Pub. No.: US 2023/0406310 A1
(43) Pub. Date: Dec. 21, 2023

(54) CONTROL METHOD AND DEVICE FOR VEHICLE, STORAGE MEDIUM, ELECTRONIC DEVICE AND VEHICLE

(71) Applicant: Beijing CHJ Information Technology Co., Ltd., Beijing (CN)

(72) Inventor: Guangping WANG, Beijing (CN)

(21) Appl. No.: 18/254,649

(22) PCT Filed: Nov. 23, 2021
(86) PCT No.: PCT/CN2021/132491

§ 371 Date: May 26, 2023

(30) Foreign Application Priority Data
Nov. 26, 2020 (CN) 202011349236.8

(51) Int. Cl. B60W 30/18

(52) U.S. Cl. CPC B60W 30/18072; B60W 30/18109; B60W 2540/30; B60W 2540/10; B60W 2540/12; B60W 2556/10; B60W 2520/10; B60W 2520/105; B60W 2554/802; B60W 2554/804; B60W 2710/18

(57) ABSTRACT

A control method for a vehicle includes determining a target gliding duration and a target deceleration of a user according to a target driving habit model when receiving a braking command; controlling the vehicle to glide in a target period, in which the target period takes a moment when the braking command is received as a starting time point, and a duration of the target period corresponds to the target gliding duration; and controlling the vehicle to brake according to the target deceleration when reaching an ending time point of the target period.

### CROSS-REFERENCE TO RELATED APPLICATIONS

This application is U.S. national phase entry under 35 U.S.C. § 371 of International Application No. PCT/CN2021/132491, filed Nov. 23, 2021, which claims priority to Chinese Patent Application No. 202011349236.8, filed Nov. 26, 2020, the entire disclosures of which are incorporated herein by reference.

### FIELD

The present disclosure relates to a field of vehicle control, and more particularly to a control method for a vehicle, a control device for a vehicle, a storage medium, an electronic device and a vehicle.

### BACKGROUND

When a vehicle is gliding, a certain braking torque is usually applied by a motor, and kinetic energy is converted into electric energy and stored in an energy storage device while the vehicle is gliding and decelerating, so as to recover braking energy. At present, a magnitude of the braking torque is usually set by a research and development engineer based on an empirical value, and a deceleration trend during gliding is the same, which cannot meet different needs of different drivers for driving experience. In addition, a user may set a recovery intensity level by himself/herself. In this way, the user needs to set the intensity level manually, which is not simple, and is difficult for the user to select a suitable intensity level from a variety of intensities.

### SUMMARY

An object of the present disclosure is to provide a control method for a vehicle, a control device for a vehicle, a storage medium, an electronic device and a vehicle, which are capable of adaptively recovering braking energy and improving driving experience of a driver.

According to a first aspect of the present disclosure, a control method for a vehicle is provided. The method includes: determining a target gliding duration and a target deceleration of a user according to a target driving habit model when receiving a braking command; controlling the vehicle to glide in a target period, in which the target period takes a moment when the braking command is received as a starting time point, and a duration of the target period corresponds to the target gliding duration; and controlling the vehicle to brake according to the target deceleration when reaching an ending time point of the target period.

In some embodiments of the present disclosure, the method further includes: obtaining state information of an accelerator pedal of the vehicle; and determining that the braking command is received when the state information indicates that the accelerator pedal is in a released state.

In some embodiments of the present disclosure, the braking command includes a target vehicle motion parameter. The method further includes determining as the target driving habit model a driving habit model corresponding to the target vehicle motion parameter according to driving habit models corresponding to preset vehicle motion parameters when the braking command is received.

In some embodiments of the present disclosure, the driving habit models corresponding to the preset vehicle motion parameters are obtained by: acquiring historical gliding durations and historical decelerations of the user corresponding to each of the preset vehicle motion parameters in historical braking processes, in which each of the historical gliding durations is a duration from releasing an accelerator pedal to depressing a brake pedal in the respective historical braking process, and each of the historical decelerations is determined according to a maximum deceleration in the respective historical braking process; determining a preferential gliding duration corresponding to the preset vehicle motion parameter according to the historical gliding durations; and determining a preferential deceleration corresponding to the preset vehicle motion parameter according to the historical decelerations.

In some embodiments of the present disclosure, determining the preferential gliding duration corresponding to the preset vehicle motion parameter according to the historical gliding durations includes any of:
determining the preferential gliding duration according to an average value of the historical gliding durations;
determining the preferential gliding duration according to a median value of the historical gliding durations; or
determining the preferential gliding duration according to a highest frequency historical gliding duration of the historical gliding durations;
and/or
determining the preferential deceleration corresponding to the preset vehicle motion parameter according to the historical decelerations includes any of:
determining the preferential deceleration according to an average value of the historical decelerations;
determining the preferential deceleration according to a median value of the historical decelerations; or
determining the preferential deceleration according to a highest frequency historical deceleration of the historical decelerations.

In some embodiments of the present disclosure, the target vehicle motion parameter includes a speed and/or an acceleration of the vehicle. The preset vehicle motion parameter includes a speed and/or an acceleration of the vehicle.

In some embodiments of the present disclosure, the target driving habit model includes a preferential gliding duration and a preferential deceleration of the user. Determining the target gliding duration and the target deceleration of the user according to the target driving habit model includes: determining the target gliding duration according to the preferential gliding duration of the user in the target driving habit model; and determining the target deceleration according to the preferential deceleration of the user in the target driving habit model.

In some embodiments of the present disclosure, determining the target deceleration according to the preferential deceleration of the user in the target driving habit model includes: determining as a first deceleration the preferential deceleration of the user in the target driving habit model; acquiring traffic information around the vehicle, in which the traffic information includes a distance between the vehicle and a target object in front of the vehicle, and a relative speed between the vehicle and the target object; determining a second deceleration capable of ensuring safety of the vehicle according to the traffic information; and obtaining the target deceleration by weighting the first deceleration, the second deceleration, a first weight corresponding to the first deceleration, and a second weight corresponding to the second deceleration.

In some embodiments of the present disclosure, the second weight is obtained by determining as the second weight a weight corresponding to the acquired traffic information according to the acquired traffic information and a relationship between preset traffic information and weights.

In some embodiments of the present disclosure, controlling the vehicle to brake according to the target deceleration includes: determining a target braking torque corresponding to the target deceleration; and controlling the vehicle to brake according to the target braking torque.

In some embodiments of the present disclosure, determining the target braking torque corresponding to the target deceleration includes: inputting the target deceleration into a pre-trained vehicle dynamic model to obtain a torque result output by the vehicle dynamic model; and obtaining the target braking torque according to the torque result.

According to a second aspect of the present disclosure, an electronic device is provided. The electronic device includes a processor and a memory for storing computer programs executable by the processor, and the processor is configured to execute the computer programs to perform steps of the control method according to the first aspect of the present disclosure.

According to a third aspect of the present disclosure, a vehicle is provided. The vehicle is configured to perform the control method according to the first aspect of the present disclosure.

Additional features and advantages of the present disclosure will be described in detail in the following embodiments of the present disclosure.

### BRIEF DESCRIPTION OF THE DRAWINGS

The drawings, which are included to provide a further understanding of the present disclosure and constitute a part of this specification, illustrate embodiments of the present disclosure and together with the description serve to explain the present disclosure, but shall not be construed to limit the present disclosure, in which:

FIG. 1 is a flow chart of a control method for a vehicle in some embodiments of the present disclosure;

FIG. 2 is a block diagram of a control device for a vehicle in some embodiments of the present disclosure;

FIG. 3 is a block diagram of an electronic device in some embodiments of the present disclosure.

### DETAILED DESCRIPTION

The embodiments of the present disclosure are described in detail below. The embodiments described herein with reference to drawings are explanatory, and used to generally understand the present disclosure. The embodiments shall not be construed to limit the present disclosure.

It should be noted that the numerals of the steps as described in the embodiments of the present disclosure are not used to limit the execution sequence relationship between the steps, but the steps may be executed in a different order and/or concurrently.

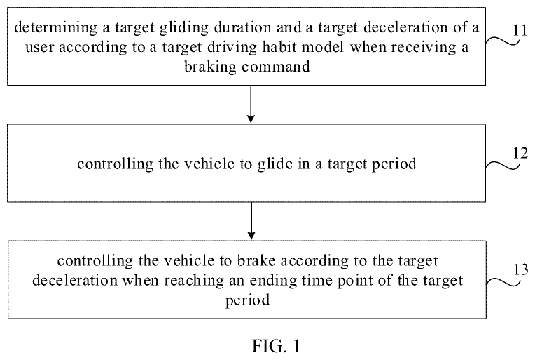

FIG. 1 is a flow chart of a control method for a vehicle in some embodiments of the present

disclosure. The method provided in the present disclosure may be applied to any devices for controlling vehicles, such as a vehicle control unit. As shown in FIG. 1, the method may include step 11 to step 13.

In step 11, a target gliding duration and a target deceleration of a user are determined according to a target driving habit model when receiving a braking command.

In step 12, the vehicle is controlled to glide in a target period.

In step 13, the vehicle is controlled to brake according to the target deceleration when reaching an ending time point of the target period.

The target period takes a moment when the braking command is received as a starting time point, and a duration of the target period is the target gliding duration.

In some embodiments of the present disclosure, the vehicle is provided with a brake button. When it is detected that the brake button is triggered by the user, it may be determined that the brake command is received.

In other embodiments of the present disclosure, the method provided in the present disclosure may further include:
obtaining state information of an accelerator pedal of the vehicle; and
determining that the braking command is received when the state information indicates that the accelerator pedal is in a released state.

That is to say, when it is detected that the accelerator pedal is released, it may be determined that the braking command is received. The accelerator pedal is in the released state, which may mean that the accelerator pedal is in a fully released state, that is, the accelerator pedal is completely released.

In addition, the braking command includes a target vehicle motion parameter. The target vehicle motion parameter includes a speed and/or an acceleration of the vehicle. For example, the speed of the vehicle may be obtained by a vehicle speed sensor provided in the vehicle. As an example, the acceleration of the vehicle may be obtained by an acceleration sensor provided in the vehicle. As another example, the acceleration of the vehicle may be obtained by collecting the speed of the vehicle and using an existing algorithm according to the speed of the vehicle.

In this way, it may be detected whether the braking command is received in real time. When the braking command is received, step 11 is executed, and the target gliding duration and the target deceleration corresponding to the user may be determined through the target driving habit model.

The target driving habit model is generated based on the user's driving habit. The target driving habit model may be stored in a preset storage unit of the vehicle, such as a vehicle control unit (VCU).

In some embodiments of the present disclosure, a plurality of alternative driving habit models may be pre-trained and stored, and a current driving habit model to be used (i.e., a target habit model) is selected from the plurality of models based on the braking command. In some embodiments of the present disclosure, the method provided in the present disclosure may further include the following steps.

When the braking command is received, a driving habit model corresponding to the target vehicle motion parameter is determined as the target driving habit model according to driving habit models corresponding to preset vehicle motion parameters.

That is to say, the method provided in the present disclosure includes a plurality of preset vehicle motion parameters. The preset vehicle motion parameter includes a speed and/or an acceleration of the vehicle. The preset vehicle motion parameter may be a preset speed and/or a preset acceleration. In the preset vehicle motion parameters, each preset vehicle motion parameter corresponds to its respective driving habit model. Therefore, the target driving habit model may be determined from these existing driving habit models according to the actual target vehicle motion parameter of the vehicle.

In some embodiments of the present disclosure, the driving habit models corresponding to the preset vehicle motion parameters may be obtained by acquiring historical gliding durations and historical decelerations of the user corresponding to each of the preset vehicle motion parameters in historical braking processes; determining a preferential gliding duration corresponding to the preset vehicle motion parameter is according to the historical gliding durations; and determining a preferential deceleration corresponding to the preset vehicle motion parameter according to the historical decelerations.

This is to say, based on data generated by the user in each historical braking process, data corresponding to the preset vehicle motion parameters is extracted therefrom to train the driving habit models corresponding to the preset vehicle motion parameters. The model training method for each preset vehicle motion parameter is the same.

The historical gliding duration is a duration from releasing an accelerator pedal to depressing a brake pedal in a historical braking process. The historical deceleration may be determined according to a maximum deceleration in the historical braking process. For example, a product of a maximum deceleration in the historical braking process and a preset coefficient may be used as a historical deceleration corresponding to the historical braking process. For example, the preset coefficient may be 80%.

According to a plurality of historical gliding durations obtained from a plurality of historical braking processes, a preferential gliding duration of the user may be further determined.

In some embodiments of the present disclosure, determining the preferential gliding duration corresponding to the preset vehicle motion parameter according to the historical gliding durations includes any of:
determining the preferential gliding duration according to an average value of the historical gliding durations;
determining the preferential gliding duration according to a median value of the historical gliding durations; or
determining the preferential gliding duration according to a highest frequency historical gliding duration of the historical gliding durations.

As an example, the plurality of obtained historical gliding durations may be first averaged to obtain an average value, and the obtained average value may be determined as the preferential gliding duration. As another example, a median value of the plurality of obtained historical gliding durations may be obtained, and the obtained median value may be determined as the preferential gliding duration. As another example, the highest frequency historical gliding duration of the plurality of obtained historical gliding durations may be determined as the preferential gliding duration.

In some embodiments of the present disclosure, determining the preferential deceleration corresponding to the preset vehicle motion parameter according to the historical decelerations includes any of:
determining the preferential deceleration according to an average value of the historical decelerations;
determining the preferential deceleration according to a median value of the historical decelerations; or
determining the preferential deceleration according to a highest frequency historical deceleration of the historical decelerations.

As an example, the plurality of obtained historical decelerations may be first averaged to obtain an average value, and the obtained average value may be determined as the preferential deceleration. As another example, a median value of the plurality of obtained historical decelerations may be obtained, and the obtained median value may be determined as the preferential deceleration. As another example, the highest frequency historical deceleration of the plurality of obtained historical decelerations may be determined as the preferential deceleration.

Therefore, based on a plurality of existing models and the target vehicle motion parameter included in the braking command, the target driving habit model in line with the target vehicle motion parameter may be determined, which may be used for subsequent data processing based on the target driving habit model.

As the above-mentioned driving habit model, the target driving habit model includes the preferential gliding duration and the preferential deceleration of the user, such that it is easy to obtain the target gliding duration and the target deceleration corresponding to the user.

Step 11 may include the following steps: determining the target gliding duration according to the preferential gliding duration of the user in the target driving habit model; and determining the target deceleration according to the preferential deceleration of the user in the target driving habit model.

In some embodiments of the present disclosure, determining the target gliding duration according to the preferential gliding duration of the user in the target driving habit model may include directly determining the preferential gliding duration of the user in the target driving habit model as the target gliding duration.

In this way, the target gliding duration may be determined quickly, and the data may be processed quickly.

In other embodiments of the present disclosure, determining the target gliding duration according to the preferential gliding duration of the user in the target driving habit model may include pre-calculating the preferential gliding duration of the user recorded in the target driving habit model and a preset value to obtain a result, and determining the obtained result as the target gliding duration.

In some embodiments of the present disclosure, the pre-calculating may be performed by multiplication, addition or subtraction.

In some embodiments of the present disclosure, determining the target deceleration according to the preferential deceleration of the user in the target driving habit model may include directly determining the preferential deceleration of the user in the target driving habit model as the target deceleration.

In this way, the target deceleration may be determined quickly, and the data may be processed quickly.

In other embodiments of the present disclosure, determining the target deceleration according to the preferential deceleration of the user in the target driving habit model includes: determining as a first deceleration the preferential deceleration of the user in the target driving habit model; acquiring traffic information around the vehicle; determining a second deceleration capable of ensuring safety of the vehicle according to the traffic information; and obtaining the target deceleration by weighting the first deceleration, the second deceleration, a first weight corresponding to the first deceleration, and a second weight corresponding to the second deceleration.

The traffic information includes a distance between the vehicle and a target object in front of the vehicle, and a relative speed between the vehicle and the target object. The target object may be other vehicles, obstacles, traffic lights, etc. For example, the traffic information may be acquired by one or more of vehicle radars, cameras, and interne of vehicles (Vehicle to X, V2X).

After acquiring traffic information, the second deceleration may be determined according to the traffic information. The second deceleration is a deceleration, which is capable of ensuring safe travelling of the vehicle. For example, if the traffic information includes a distance between the vehicle and a vehicle in front of the vehicle, and a relative speed between the vehicle and the front vehicle, the second deceleration should be determined for a purpose of not colliding with the front vehicle. For another example, if the traffic information includes a distance between a vehicle and a traffic light, and a relative speed (that is, a vehicle speed) between the vehicle and the traffic light, and when the traffic light is a red light, the second deceleration should be determined as a deceleration capable of stopping the vehicle before a stop line in order that the vehicle does not run the red light.

After determining the first deceleration and the second deceleration, the target deceleration may be obtained by weighting the first deceleration, the second deceleration, the first weight corresponding to the first deceleration, and the second weight corresponding to the second deceleration.

A sum of the first weight and the second weight is 1, and each of them is greater than or equal to 0, and less than or equal to 1.

In some embodiments of the present disclosure, the first weight and the second weight may be preset fixed values.

In some embodiments of the present disclosure, the second weight is obtained by determining as the second weight a weight corresponding to the acquired traffic information according to the acquired traffic information and a relationship between preset traffic information and weights.

In some embodiments of the present disclosure, a distance interval between the vehicle and the front vehicle may be set, and a weight value corresponding to each distance interval may be set. Then, according to the acquired traffic information, the distance interval to which the distance between the vehicle and the front vehicle belongs may be determined, and then the weight value corresponding to the distance interval may be obtained as the second weight.

For example, a preset weight corresponding to a distance between the vehicle and the front vehicle of less than 50 m is 0.8, a preset weight corresponding to a distance between the vehicle and the front vehicle between 50 m and 100 m is 0.5, and a preset weight corresponding to a distance between the vehicle and the front vehicle of greater than 100 m is 0.2. When the acquired traffic information indicates that the distance between the vehicle and the front vehicle is 58 m, the second weight may be determined to be 0.5. For another example, a preset weight corresponding to a speed of the vehicle of lower than 20 km/h is 0. When the speed of the vehicle is lower than 20 km/h, the second weight may be determined as 0.

In the above-mentioned method, by combining the target driving habit model with actual traffic conditions, the target deceleration may be obtained through weighted calculation, which may not only ensure safety, but also meet the driver's driving habits.

In step 12, the vehicle is controlled to glide in the target period.

The target period takes the moment when the braking command is received as the starting time point, and the duration of the target period corresponds to the target gliding duration. That is to say, from the moment when the braking command is received, the vehicle is controlled to glide until the target gliding duration is reached, which belongs to the gliding stage of the vehicle.

In step 13, the vehicle is controlled to brake according to the target deceleration when reaching the ending time point of the target period.

In some embodiments of the present disclosure, controlling the vehicle to brake according to the target deceleration may include determining a target braking torque corresponding to the target deceleration, and controlling the vehicle to brake according to the target braking torque.

In some embodiments of the present disclosure, after determining the target deceleration, the braking torque corresponding to the target deceleration may be calculated according to a conversion formula between the deceleration and the braking torque. The conversion between the deceleration and the braking torque belongs to common knowledge in the art, and the specific calculation way will be not listed here.

In some embodiments of the present disclosure, determining the target braking torque corresponding to the target deceleration includes inputting the target deceleration into a pre-trained vehicle dynamic model to obtain a torque result output by the vehicle dynamic model, and obtaining the target braking torque according to the torque result.

The target deceleration is input into the vehicle dynamic model, and the vehicle dynamic model will obtain a torque result by calculation based on information such as the target deceleration, a slope, the vehicle speed, and a vehicle mass. The vehicle dynamic model considers vehicle dynamics factors, including tire resistance, air resistance, internal resistance (including mechanical losses, inertial factors, etc.), acceleration resistance, and slope resistance, which are conventional methods in vehicle dynamics, and will not be described here.

In some embodiments of the present disclosure, after obtaining the torque result, the torque result may be directly used as the target braking torque. In some embodiments of the present disclosure, after obtaining the torque result, the torque result may be subjected to drivability filtering (e.g., first-order lag filtering) to obtain the target braking torque.

In the above-mentioned technical solutions of the present disclosure, when receiving the braking command, the target gliding duration and the target deceleration of the user are determined according to the target driving habit model. The vehicle is controlled to glide in the target period. The target period takes the moment when the braking command is received as the starting time point, and the duration of the target period corresponds to the target gliding duration. When reaching the ending time point of the target period, the vehicle is controlled to brake according to the target deceleration. In this way, the target gliding duration and the target deceleration may be obtained according to the target driving habit model, and the vehicle may be controlled to brake according to the target gliding duration and the target deceleration. The target driving habit model may reflect a braking habit of the user, such that the determined target gliding duration and the determined target deceleration may be in line with the driving habit of the user. In addition, in controlling the vehicle, kinetic energy generated in gliding may be converted into electric energy for storage, thereby recovering braking energy adaptively without additional manual control by the user, and improving the user's driving experience.

FIG. 2 is a block diagram of a control device for a vehicle in some embodiments of the present disclosure. As shown in FIG. 2, the device 20 includes a first determining module 21, a first control module 22 and a second control module 23. The first determining module 21 is configured to determine a target gliding duration and a target deceleration of a user according to a target driving habit model when receiving a braking command. The first control module 22 is configured to control the vehicle to glide in a target period. The target period takes a moment when the braking command is received as a starting time point, and a duration of the target period corresponds to the target gliding duration. The second control module 23 is configured to control the vehicle to brake according to the target deceleration when reaching an ending time point of the target period.

In some embodiments of the present disclosure, the device 20 further includes an obtaining module configured to obtain state information of an accelerator pedal of the vehicle. The device 20 is configured to determine that the braking command is received when the state information indicates that the accelerator pedal is in a released state.

In some embodiments of the present disclosure, the braking command includes a target vehicle motion parameter. The device 20 further includes a second determining module. The second determining module is configured to determine as the target driving habit model a driving habit model corresponding to the target vehicle motion parameter according to driving habit models corresponding to preset vehicle motion parameters when the braking command is received.

In some embodiments of the present disclosure, the device 20 is configured to obtain the driving habit models corresponding to the preset vehicle motion parameters by the following modules. An acquisition sub-module is configured to acquire historical gliding durations and historical decelerations of the user corresponding to each of the preset vehicle motion parameters in historical braking processes. Each of the historical gliding durations is a duration from releasing an accelerator pedal to depressing a brake pedal in the respective historical braking process, and each of the historical decelerations is determined according to a maximum deceleration in the respective historical braking process. A second determining sub-module is configured to determine a preferential gliding duration corresponding to the preset vehicle motion parameter according to the historical gliding durations. A third determining sub-module is configured to determine a preferential deceleration corresponding to the preset vehicle motion parameter according to the historical decelerations.

In some embodiments of the present disclosure, the second determining sub-module is configured to determine the preferential gliding duration in any one of the following ways. The preferential gliding duration is determined according to an average value of the historical gliding durations. The preferential gliding duration is determined according to a median value of the historical gliding durations. The preferential gliding duration is determined according to a highest frequency historical gliding duration of the historical gliding durations.

The third determining sub-module is configured to determine the preferential deceleration in any one of the following ways. The preferential deceleration is determined according to an average value of the historical decelerations. The preferential deceleration is determined according to a median value of the historical decelerations. The preferential deceleration is determined according to a highest frequency historical deceleration of the historical decelerations.

In some embodiments of the present disclosure, the target vehicle motion parameter includes a speed and/or an acceleration of the vehicle. The preset vehicle motion parameter includes a speed and/or an acceleration of the vehicle.

In some embodiments of the present disclosure, the target driving habit model includes the preferential gliding duration and the preferential deceleration of the user. The first determining module 21 includes a fourth determining sub-module and a fifth determining sub-module. The fourth determining sub-module is configured to determine the target gliding duration according to the preferential gliding duration of the user in the target driving habit model. The fifth determining sub-module is configured to determine the target deceleration according to the preferential deceleration of the user in the target driving habit model.

In some embodiments of the present disclosure, the fifth determining sub-module is configured to: determine as a first deceleration the preferential deceleration of the user in the target driving habit model; acquire traffic information around the vehicle; determine a second deceleration capable of ensuring safety of the vehicle according to the traffic information; and obtain the target deceleration by weighting the first deceleration, the second deceleration, a first weight corresponding to the first deceleration, and a second weight corresponding to the second deceleration. The traffic information includes a distance between the vehicle and a target object in front of the vehicle, and a relative speed between the vehicle and the target object.

In some embodiments of the present disclosure, the second weight is obtained by determining as the second weight a weight corresponding to the acquired traffic information according to the acquired traffic information and a relationship between preset traffic information and weights.

In some embodiments of the present disclosure, the second control module 23 includes a sixth determining sub-module and a control sub-module. The sixth determining sub-module is configured to determine a target braking torque corresponding to the target deceleration. The control sub-module is configured to control the vehicle to brake according to the target braking torque.

In some embodiments of the present disclosure, the sixth determining sub-module is configured to input the target deceleration into a pre-trained vehicle dynamic model to obtain a torque result output by the vehicle dynamic model, and obtain the target braking torque according to the torque result.

In the devices of the above-mentioned embodiments, the specific operation manner in each module has been described in detail in the relevant method embodiments, and will not be described in detail here.

The present disclosure provides a vehicle for performing the control method for the vehicle according to any one of the embodiments of the present disclosure.

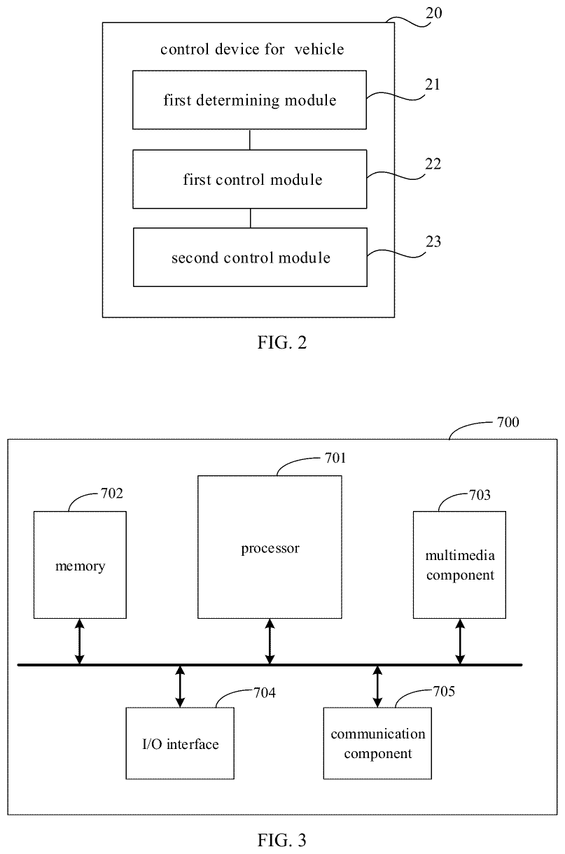

FIG. 3 is a block diagram of an electronic device 700 in some embodiments of the present disclosure. As shown in FIG. 3, the electronic device 700 may include a processor 701, and a memory 702. The electronic device 700 may further include one or more of a multimedia component 703, an input/output (I/O) interface 704 and a communication component 705.

The processor 701 is configured to control entire operation of the electronic device 700 to perform all or part of the steps in the above-mentioned control method for the vehicle. The memory 702 is configured to store various types of data for supporting operations on the electronic device 700, and such data may include instructions for any application or method operating on the electronic device 700, and application-related data, such as contact data, sent and received messages, pictures, audio, video, and so on. The memory 702 may be implemented using any type of volatile and non-volatile storage devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disc. The multimedia component 703 includes a screen and an audio component. For example, the screen may be a touch panel. The audio component is configured to output and/or input audio signals. For example, the audio component includes a microphone configured to receive an external audio signal. The received audio signal may be further stored in the memory 702 or transmitted via the communication component 705. The audio component further includes a speaker configured to output audio signals. The I/O interface 704 provides an interface between the processor 701 and other interface modules, such as a keyboard, a click wheel, a button, and the like. The button may be a virtual button or a physical button. The communication component 705 is configured to facilitate communication, wired or wirelessly, between the electronic device 700 and other devices. The wireless communication may be, for example, Wi-Fi, Bluetooth, Near Field Communication (NFC), 2G, 3G, 4G, NB-IOT, eMTC or other 5G or a combination thereof, and is not limited here. Therefore, the corresponding communication component 705 may include a Wi-Fi module, a Bluetooth module, an NFC module and so on.

In some embodiments of the present disclosure, the electronic device 700 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above-mentioned control method for the vehicle.

In some embodiments of the present disclosure, there is also provided a computer readable storage medium including instructions that, when executed by the processor, cause the processor to perform the above-mentioned control method for the vehicle. For example, the computer-readable storage medium may be the above-mentioned memory 702 including program instructions, and the above-mentioned program instructions may be executed by the processor 701 in the electronic device 700 to perform the above-mentioned control method for the vehicle.

The preferred embodiments of the present disclosure have been described in detail above with reference to the accompanying drawings. However, the present disclosure is not limited to the specific details of the above-mentioned embodiments. Within the scope of the technical concept of the present disclosure, various simple modifications can be made to the technical solutions of the present disclosure. These simple modifications all fall within the protection scope of the present disclosure.

In addition, it should be noted that each specific technical feature described in the above- mentioned embodiments may be combined in any suitable manner in a case of no contradiction. In order to avoid unnecessary repetition, various possible combinations are not described in the present disclosure.

In addition, the various embodiments of the present disclosure can also be arbitrarily combined, which should also be regarded as the contents disclosed in the present disclosure, as long as they do not violate the spirit of the present disclosure.

1. A control method for a vehicle, comprising:
determining a target gliding duration and a target deceleration of a user according to a target driving habit model when receiving a braking command;
controlling the vehicle to glide in a target period, wherein the target period takes a moment when the braking command is received as a starting time point, and a duration of the target period corresponds to the target gliding duration; and
controlling the vehicle to brake according to the target deceleration when reaching an ending time point of the target period.

2. The method according to claim 1, further comprising:
obtaining state information of an accelerator pedal of the vehicle; and
determining that the braking command is received when the state information indicates that the accelerator pedal is in a released state.

3. The method according to claim 1, wherein the braking command comprises a target vehicle motion parameter, and the method further comprises:
determining as the target driving habit model a driving habit model corresponding to the target vehicle motion parameter according to driving habit models corresponding to preset vehicle motion parameters when the braking command is received.

4. The method according to claim 3, wherein the driving habit models corresponding to the preset vehicle motion parameters are obtained by:
acquiring historical gliding durations and historical decelerations of the user corresponding to each of the preset vehicle motion parameters in historical braking processes, wherein each of the historical gliding durations is a duration from releasing an accelerator pedal to depressing a brake pedal in the respective historical braking process, and each of the historical decelerations is determined according to a maximum deceleration in the respective historical braking process;
determining a preferential gliding duration corresponding to the preset vehicle motion parameter according to the historical gliding durations; and
determining a preferential deceleration corresponding to the preset vehicle motion parameter according to the historical decelerations.

5. The method according to claim 4, wherein determining the preferential gliding duration corresponding to the preset vehicle motion parameter according to the historical gliding durations comprises any of:
determining the preferential gliding duration according to an average value of the historical gliding durations;
determining the preferential gliding duration according to a median value of the historical gliding durations; or
determining the preferential gliding duration according to a highest frequency historical gliding duration of the historical gliding durations;
and/or
determining the preferential deceleration corresponding to the preset vehicle motion parameter according to the historical decelerations comprises any of:
determining the preferential deceleration according to an average value of the historical decelerations;
determining the preferential deceleration according to a median value of the historical decelerations; or
determining the preferential deceleration according to a highest frequency historical deceleration of the historical decelerations.

6. The method according to claim 5, wherein:
the target vehicle motion parameter comprises a speed and/or an acceleration of the vehicle; and
the preset vehicle motion parameter comprises a speed and/or an acceleration of the vehicle.

7. The method according to claim 1, wherein the target driving habit model comprises a preferential gliding duration and a preferential deceleration of the user;
determining the target gliding duration and the target deceleration of the user according to the target driving habit model comprises:
determining the target gliding duration according to the preferential gliding duration of the user in the target driving habit model; and
determining the target deceleration according to the preferential deceleration of the user in the target driving habit model.

8. The method according to claim 7, wherein determining the target deceleration according to the preferential deceleration of the user in the target driving habit model comprises:
determining as a first deceleration the preferential deceleration of the user in the target driving habit model;
acquiring traffic information around the vehicle, wherein the traffic information comprises a distance between the vehicle and a target object in front of the vehicle, and a relative speed between the vehicle and the target object;
determining a second deceleration capable of ensuring safety of the vehicle according to the traffic information; and
obtaining the target deceleration by weighting the first deceleration, the second deceleration, a first weight corresponding to the first deceleration, and a second weight corresponding to the second deceleration.

9. The method according to claim 8, wherein the second weight is obtained by determining as the second weight a weight corresponding to the acquired traffic information according to the acquired traffic information and a relationship between preset traffic information and weights.

10. The method according to claim 1, wherein controlling the vehicle to brake according to the target deceleration comprises:
determining a target braking torque corresponding to the target deceleration; and
controlling the vehicle to brake according to the target braking torque.

11. The method according to claim 10, wherein determining the target braking torque corresponding to the target deceleration comprises:
inputting the target deceleration into a pre-trained vehicle dynamic model to obtain a torque result output by the vehicle dynamic model; and
obtaining the target braking torque according to the torque result.

12.-17. (canceled)

18. An electronic device, comprising:
a processor; and
a memory for storing computer programs executable by the processor;
wherein the processor is configured to execute the computer programs to:
determine a target gliding duration and a target deceleration of a user according to a target driving habit model when receiving a braking command;
control a vehicle to glide in a target period, wherein the target period takes a moment when the braking command is received as a starting time point, and a duration of the target period corresponds to the target gliding duration; and
control the vehicle to brake according to the target deceleration when reaching an ending time point of the target period.

19. A vehicle configured to:
determine a target gliding duration and a target deceleration of a user according to a target driving habit model when receiving a braking command;
control the vehicle to glide in a target period, wherein the target period takes a moment when the braking command is received as a starting time point, and a duration of the target period corresponds to the target gliding duration; and
control the vehicle to brake according to the target deceleration when reaching an ending time point of the target period.

20. The vehicle according to claim 19, wherein the vehicle is further configured to:
obtain state information of an accelerator pedal of the vehicle; and
determine that the braking command is received when the state information indicates that the accelerator pedal is in a released state.

21. The vehicle according to claim 19, wherein the braking command comprises a target vehicle motion parameter, and the vehicle is further configured to:
determine as the target driving habit model a driving habit model corresponding to the target vehicle motion parameter according to driving habit models corresponding to preset vehicle motion parameters when the braking command is received.

22. The vehicle according to claim 21, wherein the driving habit models corresponding to the preset vehicle motion parameters are obtained by:
acquiring historical gliding durations and historical decelerations of the user corresponding to each of the preset vehicle motion parameters in historical braking processes, wherein each of the historical gliding durations is a duration from releasing an accelerator pedal to depressing a brake pedal in the respective historical braking process, and each of the historical decelerations is determined according to a maximum deceleration in the respective historical braking process;
determining a preferential gliding duration corresponding to the preset vehicle motion parameter according to the historical gliding durations; and
determining a preferential deceleration corresponding to the preset vehicle motion parameter according to the historical decelerations.

23. The vehicle according to claim 22, wherein the vehicle is configured to:
determine the preferential gliding duration according to an average value of the historical gliding durations;
determine the preferential gliding duration according to a median value of the historical gliding durations; or
determine the preferential gliding duration according to a highest frequency historical gliding duration of the historical gliding durations;
and/or
determine the preferential deceleration corresponding to the preset vehicle motion parameter according to the historical decelerations comprises any of:
determine the preferential deceleration according to an average value of the historical decelerations;
determine the preferential deceleration according to a median value of the historical decelerations; or
determine the preferential deceleration according to a highest frequency historical deceleration of the historical decelerations.

24. The vehicle according to claim 23, wherein:
the target vehicle motion parameter comprises a speed and/or an acceleration of the vehicle; and
the preset vehicle motion parameter comprises a speed and/or an acceleration of the vehicle.

25. The vehicle according to claim 19, wherein the target driving habit model comprises a preferential gliding duration and a preferential deceleration of the user, and the vehicle is configured to:
determine the target gliding duration according to the preferential gliding duration of the user in the target driving habit model; and
determine the target deceleration according to the preferential deceleration of the user in the target driving habit model.

26. The vehicle according to claim 25, wherein the vehicle is configured to:
determine as a first deceleration the preferential deceleration of the user in the target driving habit model;
acquire traffic information around the vehicle, wherein the traffic information comprises a distance between the vehicle and a target object in front of the vehicle, and a relative speed between the vehicle and the target object;
determine a second deceleration capable of ensuring safety of the vehicle according to the traffic information; and
obtain the target deceleration by weighting the first deceleration, the second deceleration, a first weight corresponding to the first deceleration, and a second weight corresponding to the second deceleration.
